(19) United States
(12) Patent Application Publication
(10) Pub. No.: US 2024/0140053 A1
(43) Pub. Date: May 2, 2024

(54) Double Vacuum Debulk Processing

(71) Applicant: The Boeing Company, Arlington, VA (US)

(72) Inventors: John F. Spalding, Renton, WA (US); Marc R. Matsen, Seattle, WA (US); Gwendolyn Marie Janda, Seattle, WA (US); Karl Marius Nelson, Issaquah, WA (US); Bret Alan Mcginness Voss, Seattle, WA (US)

(21) Appl. No.: 18/491,222

(22) Filed: Oct. 20, 2023

Related U.S. Application Data
(60) Provisional application No. 63/381,348, filed on Oct. 28, 2022.

(51) Int. Cl. B29C 70/44

(52) U.S. Cl. CPC B29C 70/44; B29K 2105/0872

(57) ABSTRACT

Methods and a double vacuum processing system are presented. A method of performing a double vacuum debulk and cure on a composite laminate is presented. A composite laminate is heated to begin a double vacuum debulk of the composite laminate while vacuum is pulled in a first vacuum zone containing the composite laminate and a second vacuum zone containing the first vacuum zone. Pressure within the second vacuum zone is increased to above atmospheric pressure. Heating the composite laminate is continued to complete a cure cycle for the composite laminate while the second vacuum zone is above atmospheric pressure.

### CROSS-REFERENCE TO RELATED APPLICATION

This application claims the benefit of U.S. Provisional Patent Application Ser. No. 63/381,348, filed Oct. 28, 2022, and entitled “Improved Double Vacuum Debulk Processing,” which is incorporated herein by reference in its entirety.

### BACKGROUND INFORMATION

### 1. Field

The present disclosure relates generally to processing composite materials and more specifically to curing composite materials using a double vacuum debulk process and apparatus.

### 2. Background

Composite materials are strong, light-weight materials created by combining two or more functional components. For example, a composite material may include reinforcing fibers bound in polymer resin matrix. The fibers can take the form of a unidirectional tape, woven cloth or fabric, or a braid.

After the different layers of a composite laminate have been laid up, the layers of composite material may be consolidated and cured upon exposure to temperature and pressure, thus forming the final composite structure. Conventionally composite laminates are cured in an autoclave. Autoclaves are large, expensive, and have a high processing time. Autoclaves are often a bottleneck for manufacturing processes.

Therefore, it would be desirable to have a method and apparatus that takes into account at least some of the issues discussed above, as well as other possible issues.

### SUMMARY

An embodiment of the present disclosure provides a method of performing a double vacuum debulk and cure on a composite laminate. A vacuum is pulled within a first vacuum zone enclosing the composite laminate. A second vacuum is pulled within a second vacuum zone surrounding the first vacuum zone. The second vacuum in the second vacuum zone is released while debulking. The second vacuum zone is pressurized to greater than atmospheric pressure during debulking. The composite laminate is cured while the second vacuum zone is greater than atmospheric pressure.

Another embodiment of the present disclosure provides a method of performing a double vacuum debulk and cure on a composite laminate. The composite laminate is heated to begin a double vacuum debulk of the composite laminate while vacuum is pulled in a first vacuum zone containing the composite laminate and a second vacuum zone containing the first vacuum zone. Pressure within the second vacuum zone is increased to above atmospheric pressure. Heating of the composite laminate is continued to complete a cure cycle for the composite laminate while the second vacuum zone is above atmospheric pressure.

A further embodiment of the present disclosure provides a system. The system comprises a rigid chamber comprising walls and a cavity formed by the walls, and seals connected to the walls of the rigid chamber. The seals are configured to maintain a vacuum zone formed within the cavity between the rigid chamber and a cure tool when a positive pressure or a negative pressure is within the vacuum zone.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is an illustration of an aircraft in accordance with an illustrative embodiment;

FIG. 2 is an illustration of a block diagram of a manufacturing environment in accordance with an illustrative embodiment;

FIG. 3 is an illustration of a partial cross-sectional view of a double vacuum processing system in accordance with an illustrative embodiment;

FIG. 4 is an illustration of a partial cross-sectional view of a double vacuum processing system in accordance with an illustrative embodiment;

FIG. 5 is an illustration of a partial cross-sectional view of a double vacuum processing system in accordance with an illustrative embodiment;

FIG. 6 is an illustration of a partial cross-sectional view of a double vacuum processing system in accordance with an illustrative embodiment;

FIG. 7 is an illustration of a partial cross-sectional view of a double vacuum processing system in accordance with an illustrative embodiment;

FIG. 8 is an illustration of a partial cross-sectional view of a double vacuum processing system in accordance with an illustrative embodiment;

FIG. 9 is an illustration of a cross-sectional view of a seal of a double vacuum processing system in accordance with an illustrative embodiment;

FIG. 10 is an illustration of cure cycle graph in accordance with an illustrative embodiment;

FIG. 11 is an illustration of cure cycle graph in accordance with an illustrative embodiment;

FIG. 12 is a flowchart of a method of performing a double vacuum debulk and cure on a composite laminate in accordance with an illustrative embodiment;

FIG. 13 is a flowchart of a method of performing a double vacuum debulk and cure on a composite laminate in accordance with an illustrative embodiment;

FIG. 14 is an illustration of an aircraft manufacturing and service method in a form of a block diagram in accordance with an illustrative embodiment; and

FIG. 15 is an illustration of an aircraft in a form of a block diagram in which an illustrative embodiment may be implemented.

### DETAILED DESCRIPTION

The illustrative examples recognize and take into account one or more different considerations. The illustrative examples recognize and take into account that most aerospace composite structures are cured using autoclaves. The illustrative examples recognize and take into account that autoclaves allow for the application of high positive pressures (45 to 100+ PSI) to the curing laminate. The illustrative examples recognize and take into account that the high positive pressures result in a high-quality laminate with a very low void content.

The illustrative examples recognize and take into account that autoclaves are very expensive to acquire, maintain, and operate. Additionally, the autoclave requirement creates a bottle neck in the production system. There can be lengthy queue times for parts waiting to be cured.

The illustrative examples recognize and take into account that alternatives to autoclaves have been developed for curing composite laminates. The illustrative examples recognize and take into account that vacuum bag only pre-pregs have been developed that allow for curing under a vacuum bag for consolidation pressure. However, these vacuum bag only pre-pregs have prolonged pre-cure vacuum dwells to remove air. Further, the illustrative examples recognize and take into account that pad up plies in vacuum bag only pre-pregs can cause entrapped air resulting in high porosity. Additionally, vacuum bag only pre-pregs have only been developed in fabric form.

The illustrative examples recognize and take into account that double vacuum debulk (DVD) process has been developed to cure composites. However, the double vacuum debulk can result in frothing in low viscosity resins or in adhesives.

The illustrative examples recognize and take into account that resin infusion can be used to form composite structures. The illustrative examples recognize and take into account that resin infusion times for large pre-forms can be lengthy. The illustrative examples recognize and take into account that resin infusion can be very sensitive to vacuum leaks and atmospheric pressure. The illustrative examples recognize and take into account that vacuum leaks, weather, and altitude (of the facility) can play large role in part quality.

The illustrative examples present double vacuum debulk processes and apparatuses that allow for cure of composite laminates under greater consolidation. The illustrative examples present double vacuum debulk processes and apparatuses that perform curing with positive pressure within a second vacuum zone.

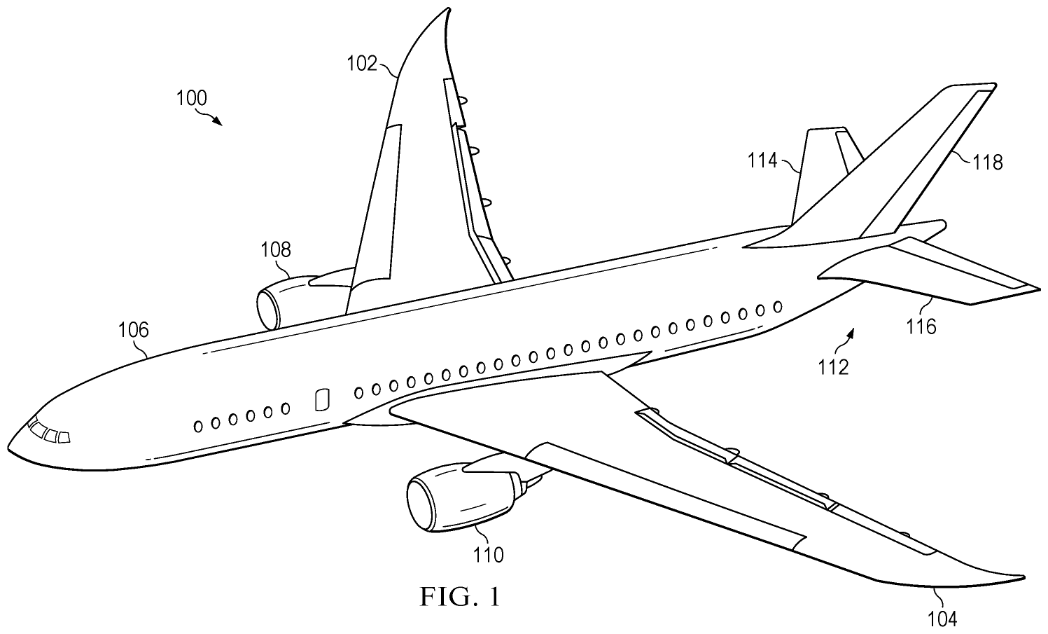

Turning now to FIG. 1, an illustration of an aircraft is depicted in accordance with an illustrative embodiment. Aircraft 100 has wing 102 and wing 104 attached to body 106. Aircraft 100 includes engine 108 attached to wing 102 and engine 110 attached to wing 104.

Body 106 has tail section 112. Horizontal stabilizer 114, horizontal stabilizer 116, and vertical stabilizer 118 are attached to tail section 112 of body 106.

Aircraft 100 is an example of an aircraft having components formed of composite products cured using double vacuum debulking. For example, a portion of wing 102 or wing 104 can be formed using double vacuum debulking. As another example, a portion of body 106 can be formed using double vacuum debulking.

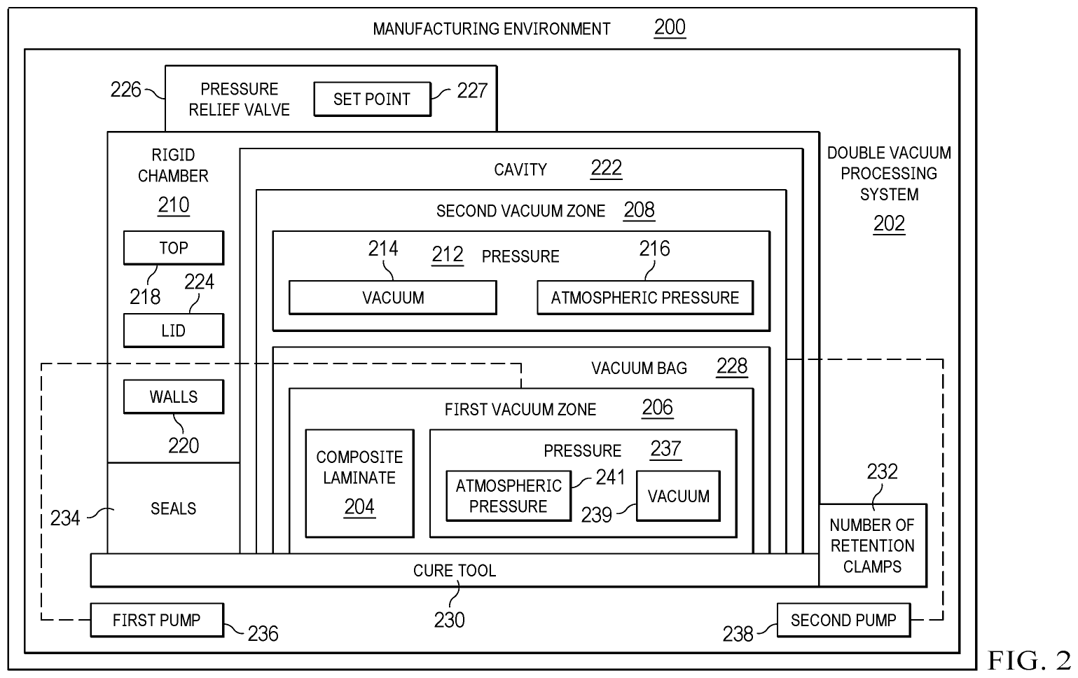

Turning now to FIG. 2, an illustration of a block diagram of a manufacturing environment is depicted in accordance with an illustrative embodiment. Portions of aircraft 100 of FIG. 1 can be manufactured in manufacturing environment 200.

Manufacturing environment 200 contains double vacuum processing system 202 configured to debulk and cure composite laminate 204. Composite laminate 204 can take any desirable form. In some illustrative examples, composite laminate 204 comprises a plurality of prepreg plies. In some illustrative examples, composite laminate 204 comprises a honeycomb core. In some illustrative examples, composite laminate 204 comprises an adhesive to bond two composite preforms. In these illustrative examples, bonding of the two composite preforms is performed as at least one of the two composite preforms is cured.

Double vacuum processing system 202 comprises first vacuum zone 206 containing composite laminate 204 and second vacuum zone 208 containing first vacuum zone 206. Second vacuum zone 208 is formed by rigid chamber 210. Rigid chamber 210 is configured to withstand pressure 212 to be applied within rigid chamber 210 during processing of composite laminate 204. Rigid chamber 210 is configured to withstand up to −1 atm pressure (vacuum) and at least +1 atm pressure. Rigid chamber 210 is configured to withstand <0.1 psia (−29.7 inHg) vacuum 214. Rigid chamber 210 is configured to withstand pressure 212 above atmospheric pressure 216. In some illustrative examples, rigid chamber 210 is also configured to withstand at least 15 psig (30 psia) pressure.

Rigid chamber 210 includes top 218 and walls 220 connected to top 218 to form cavity 222. In some illustrative examples, rigid chamber 210 can also be referred to as lid 224 of double vacuum processing system 202.

Pressure relief valve 226 is present in rigid chamber 210. Pressure relief valve 226 is configured to prevent over pressurization of rigid chamber 210. Pressure relief valve 226 connected to rigid chamber 210 is configured to release pressure above set point 227. Pressure relief valve 226 is configured to blow off excess pressure over a designed pressure for rigid chamber 210. When pressure 212 exceeds a designated pressure, pressure relief valve 226 acts to allow excess pressure to escape second vacuum zone 208.

First vacuum zone 206 is formed by vacuum bag 228 sealed to cure tool 230. Cure tool 230 is configured to support composite laminate 204 during curing.

In this illustrative example, number of retention clamps 232 is provided to retain rigid chamber 210 against cure tool 230 to maintain second vacuum zone 208 even when pressure 212 is above atmospheric pressure 216. Number of retention clamps 232 is configured to hold rigid chamber 210 against cure tool 230.

Number of retention clamps 232 takes any desirable form. Number of retention clamps 232 can be attached to cure tool 230, attached to rigid chamber 210, or loose until connecting rigid chamber 210 to cure tool 230.

Rigid chamber 210 is sealed to one of vacuum bag 228 or cure tool 230 by seals 234. Seals 234 are configured to maintain second vacuum zone 208 when pressure 212 is vacuum 214 or over atmospheric pressure 216. In these illustrative examples, seals 234 are configured to function under negative or positive pressure 212.

In some illustrative examples, seals 234 comprise a polymeric material adhered to walls 220 of rigid chamber 210 and configured to form second vacuum zone 208 when in contact with one of vacuum bag 228 or cure tool 230. In some illustrative examples, seals 234 comprise a polymeric material adhered to cure tool 230 that will form second vacuum zone 208 when in contact with rigid chamber 210.

In other illustrative examples, rigid chamber 210 is sealed to vacuum bag 228 using seals 234 such that rigid chamber 210 and vacuum bag 228 are raised and lowered together. In these illustrative examples, second vacuum zone 208 is maintained prior to forming first vacuum zone 206 around composite laminate 204 on cure tool 230. Raising and lowering rigid chamber 210 connected to vacuum bag 228 can reduce manufacturing time. In some illustrative examples, raising and lowering rigid chamber 210 connected to vacuum bag 228 can enable an automated curing process.

In some illustrative examples, when rigid chamber 210 is sealed and connected to vacuum bag 228, vacuum bag 228 is sealed to cure tool 230 by clamping or otherwise securing rigid chamber 210 to cure tool 230. In some illustrative examples, sealant material (not depicted) is applied between vacuum bag 228 and cure tool 230 to form first vacuum zone 206.

First pump 236 is connected to first vacuum zone 206. First pump 236 is configured to control pressure 237 within first vacuum zone 206. First pump 236 is configured to pull vacuum 239 within first vacuum zone 206 to degas composite laminate 204. In some illustrative examples, during cure, first vacuum zone 206 is vented to atmospheric pressure 241.

Second pump 238 is configured to control pressure 212 within second vacuum zone 208. Second pump 238 is connected to second vacuum zone 208. Second pump 238 is configured to pull vacuum 214 within second vacuum zone 208 to allow vacuum bag 228 to be slack during degas of composite laminate 204. Second pump 238 is also configured to provide positive pressure such that pressure 212 within second vacuum zone 208 is above atmospheric pressure 216.

During debulk of composite laminate 204, first pump 236 pulls vacuum 239 within first vacuum zone 206 enclosing composite laminate 204. During debulk of composite laminate 204, second pump 238 pulls a second vacuum, vacuum 214, within second vacuum zone 208 surrounding first vacuum zone 206. Composite laminate 204 is heated while vacuum 239 is within first vacuum zone 206 and vacuum 214 is within second vacuum zone 208. Vacuum 214 in second vacuum zone 208 is released. Second vacuum zone 208 is pressurized to greater than atmospheric pressure 216. Composite laminate 204 is cured while second vacuum zone 208 is greater than atmospheric pressure 216.

In some illustrative examples, during the degassing portion of the debulk, vacuum 214 is pulled within second vacuum zone 208 such that vacuum bag 228 is slack. In some illustrative examples, during compression portions of the debulk, vacuum 239 with first vacuum zone 206 is a higher vacuum than vacuum 214 in second vacuum zone 208. During some of the processing, pressure 212 in second vacuum zone 208 is greater than pressure 237 in first vacuum zone 206 to allow for compression of composite laminate 204. A higher pressure in second vacuum zone 208 applies a compression during recompression and curing. Pressure 212 and 237 are controlled during debulk and curing to prevent vacuum bag 228 from expanding or inflating.

The illustration of manufacturing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

Although not depicted, in some illustrative examples, a heat source is positioned within or on top of cure tool 230 to provide heat to composite laminate 204. As another example, illustrations of double vacuum processing system 202 are simplified for descriptive purposes only. As an example, any desirable vacuum components such as cauls, breathers, release films, or other vacuum supporting components although not depicted, can be present in first vacuum zone 206.

In some illustrative examples, vacuum bag 228 also has a pressure relief valve. In these illustrative examples, the pressure relief valve vents from first vacuum zone 206 into second vacuum zone 208. By vacuum bag 228 having a pressure relief valve, first vacuum zone 206 could be vented before pressure 212 in second vacuum zone 208 is at atmospheric pressure 216, without potentially inflating vacuum bag 228. A pressure relief valve in vacuum bag 228 can provide for greater flexibility in timing for venting of first vacuum zone 206 relative to second vacuum zone 208.

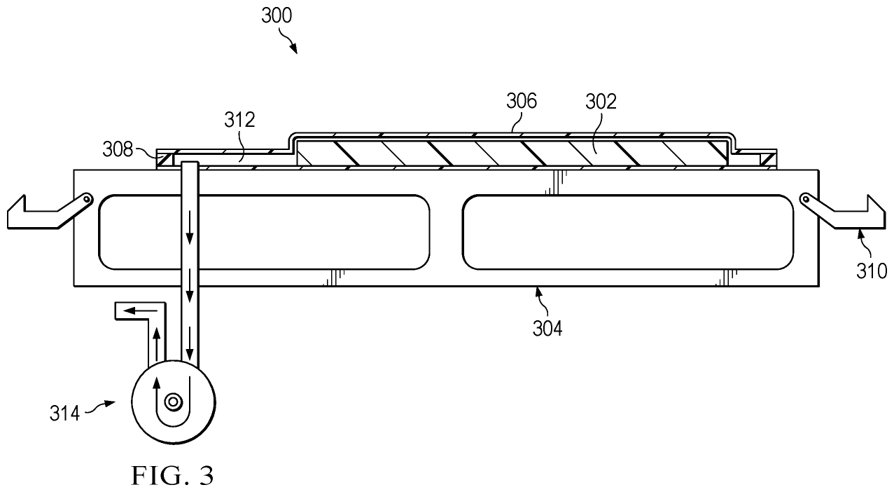

Turning now to FIG. 3, an illustration of a partial cross-sectional view of a double vacuum processing system is depicted in accordance with an illustrative embodiment. Double vacuum processing system 300 is a physical implementation of double vacuum processing system 202 of FIG. 2. Double vacuum processing system 300 is used to debulk and cure composite laminate 302. Double vacuum processing system 300 comprises cure tool 304. Cure tool 304 is configured to support a composite laminate, such as composite laminate 302, during curing. Vacuum bag 306 is sealed over composite laminate 302 by seals 308 to form first vacuum zone 312. Clamps 310 are connected to cure tool 304. Clamps 310 are configured to restrain a rigid chamber (not depicted) relative to cure tool 304 during processing of composite laminate 302.

Pump 314 is pneumatically connected to first vacuum zone 312. As depicted, pump 314 is pulling a vacuum in first vacuum zone 312.

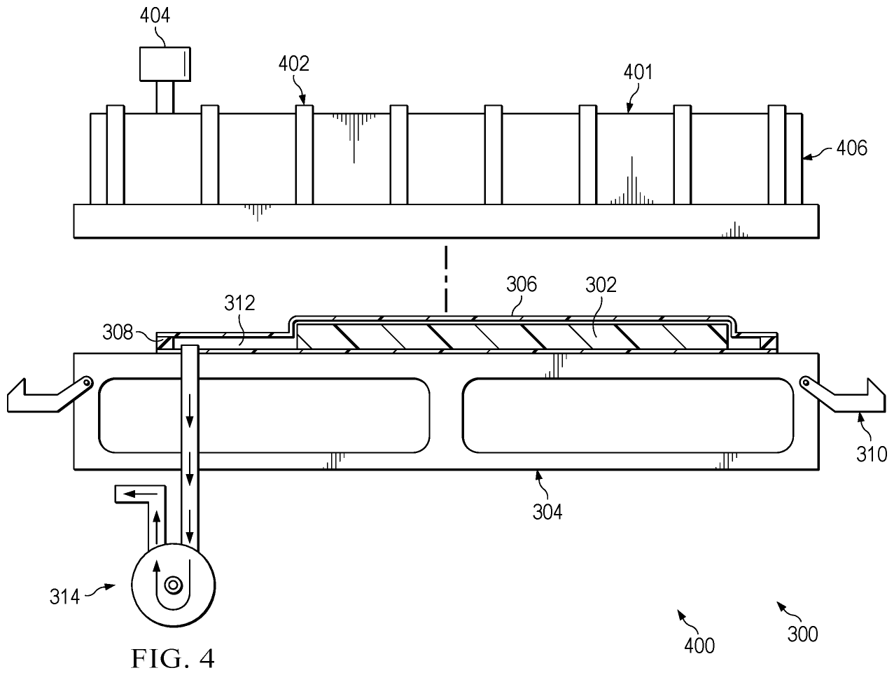

Turning now to FIG. 4, an illustration of a partial cross-sectional view of a double vacuum processing system is depicted in accordance with an illustrative embodiment. In view 400 of double vacuum processing system 300, rigid chamber 401 is positioned over cure tool 304. Rigid chamber 401 comprises top 402 and sides 406. Pressure relief valve 404 is positioned through top 402 to release excess pressure from rigid chamber 401 during operation. Clamps 310 are configured to interact with sides 406 of rigid chamber 401 to restrain rigid chamber 401 relative to cure tool 304.

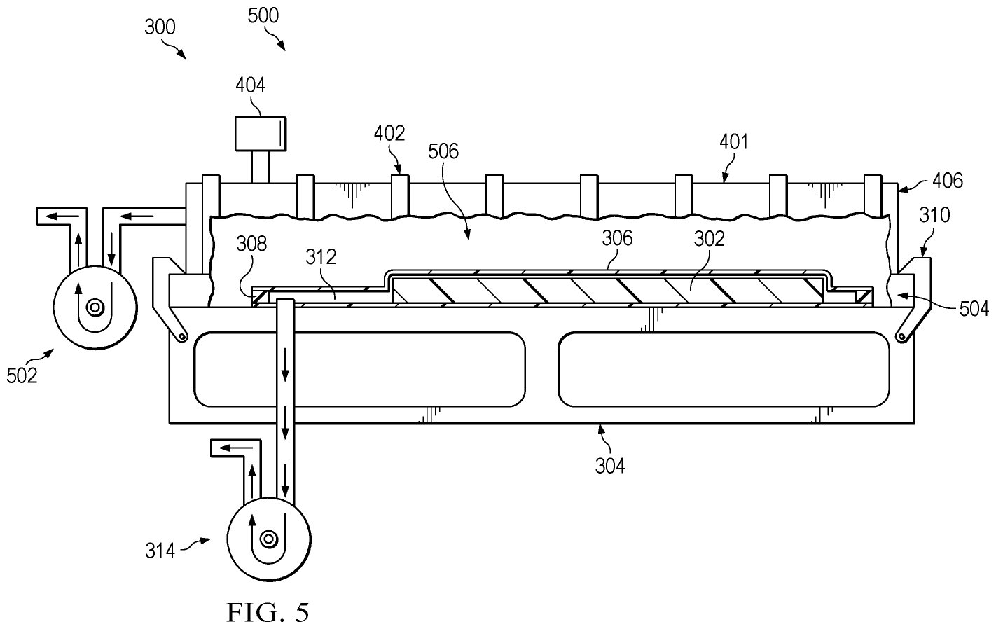

Turning now to FIG. 5, an illustration of a partial cross-sectional view of a double vacuum processing system is depicted in accordance with an illustrative embodiment. In view 500 of double vacuum processing system 300, rigid chamber 401 has been sealed to cure tool 304. Clamps 310 are engaging sides 406 of rigid chamber 401. In this illustrative example, clamps 310 grasp ridge 504 of sides 406.

In view 500, pump 314 is pulling a vacuum within first vacuum zone 312. Pump 502 is pneumatically connected to second vacuum zone 506 formed by rigid chamber 401 and cure tool 304. In view 500, pump 502 is pulling a vacuum within second vacuum zone 506.

In view 500, a double vacuum portion of the thermal cycle is depicted. The time and temperature parameters of this thermal cycle vary based on the material of composite laminate 302. During the double vacuum portion of the thermal cycle, gas extraction is performed.

During the double vacuum portion of the thermal cycle, evacuating rigid chamber 401 cancels out the clamping force provided by atmospheric pressure on vacuum bag 306. In view 500, vacuum bag 306 is slack. During the double vacuum portion of the thermal cycle, composite laminate 302 is heated to a minimum resin viscosity with no clamping but under vacuum extraction. During the double vacuum portion of the thermal cycle, entrapped air and volatiles are extracted from composite laminate 302.

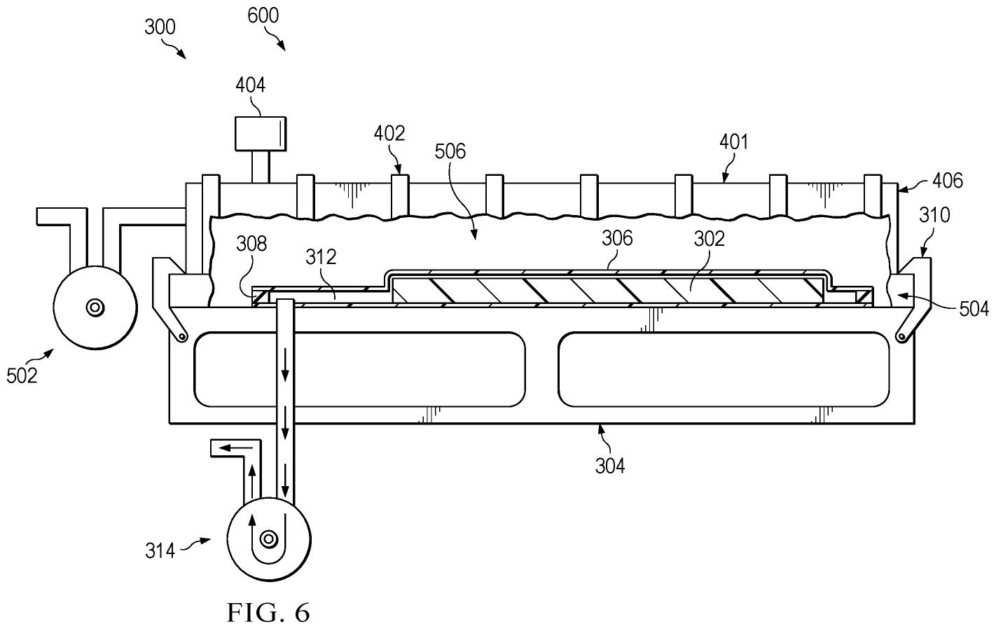

Turning now to FIG. 6, an illustration of a partial cross-sectional view of a double vacuum processing system is depicted in accordance with an illustrative embodiment. In view 600 of double vacuum processing system 300, the vacuum has been released from second vacuum zone 506. By venting second vacuum zone 506, a reconsolidation phase of the cure of composite laminate 302 is started. During the reconsolidation phase inter ply voids are collapsed and intra tow voids are filled with resin. As depicted in view 600, a vacuum is maintained on composite laminate 302 in first vacuum zone 312.

Venting second vacuum zone 506 reapplies a clamping pressure to composite laminate 302 to consolidate the plies of composite laminate 302 post air extraction.

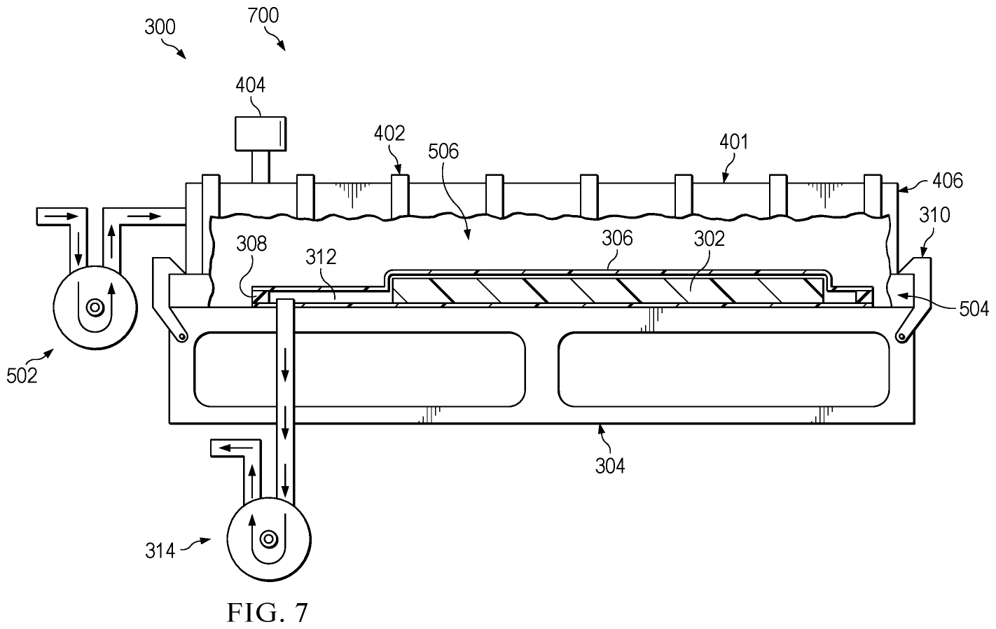

Turning now to FIG. 7, an illustration of a partial cross-sectional view of a double vacuum processing system is depicted in accordance with an illustrative embodiment. In view 700 of double vacuum processing system 300, pump 502 provides a positive pressure over atmospheric pressure to second vacuum zone 506. In view 700, vacuum is maintained in first vacuum zone 312.

A positive pressure inside second vacuum zone 506 provides a pressure pushing on vacuum bag 306. The positive pressure inside second vacuum zone 506 provides consolidation pressure and protects composite laminate 302 from air infiltration.

In some illustrative examples, the thermal cycle continues until completion with positive pressure inside second vacuum zone 506 and vacuum within first vacuum zone 312. In these illustrative examples, composite laminate 302 is cured while under vacuum in first vacuum zone 312.

The curing process follows the ideal gas law. Double vacuum processing system 300 will compress any voids by a factor of the change in pressurization. By starting with second vacuum zone 506 at 0.5 psia (−29.0 inHg) (vacuum) and increasing to 30 psia (15 psig), the compression factor is 60. A compression factor of 60 would provide approximately eight times better consolidation than an autoclave that starts at 14.7 psia (0 psig) and ends at 104.7 psia (90 psig). However, rigid chamber 401 uses at least one of less energy, less manufacturing cost, or less manufacturing time than a traditional autoclave. 30 psia is only a provided example for description, any desirable pressure over 14.7 psia may be utilized in second vacuum zone 506.

In some illustrative examples, it is desirable to reach a desired pressurization of second vacuum zone 506 prior to gelation of the resin in composite laminate 302. A desired thermal cycle for composite laminate 302 is dependent on the materials used in composite laminate 302, such as the resin type and the reinforcement type within composite laminate 302, as well as the thickness of composite laminate 302.

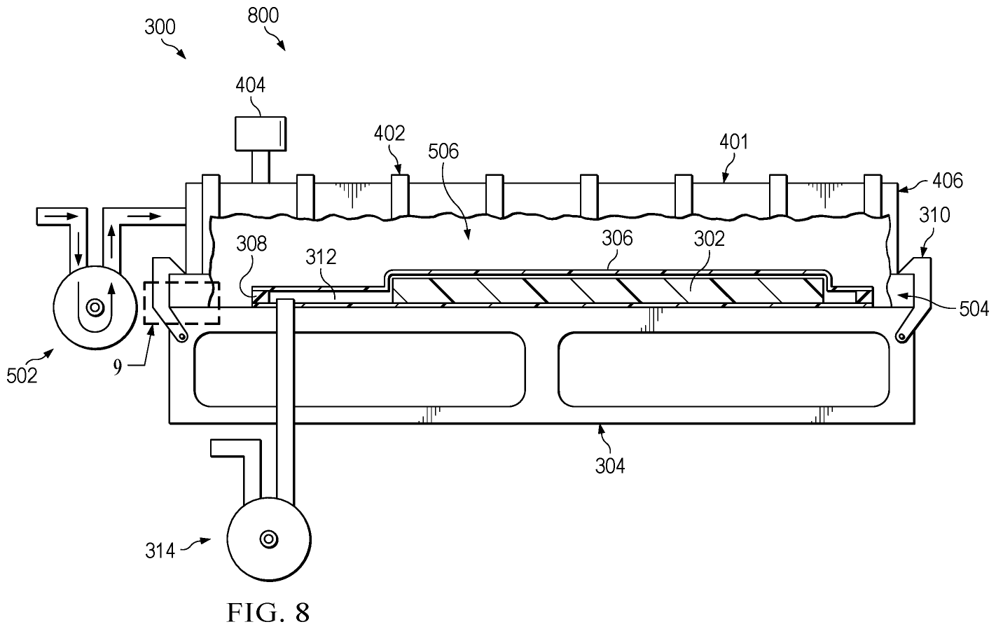

Turning now to FIG. 8, an illustration of a partial cross-sectional view of a double vacuum processing system is depicted in accordance with an illustrative embodiment. In view 800 of double vacuum processing system 300, pump 502 provides a positive pressure over atmospheric pressure to second vacuum zone 506. In view 700, the vacuum has been released in first vacuum zone 312.

Post double vacuum processing, additional porosity can occur during the single vacuum portion of the laminate cure cycle in conventional double vacuum debulk and curing. The additional porosity is due to the negative pressure within the vacuum bag causing low viscosity resins to froth.

By venting first vacuum zone 312 to atmospheric pressure, negative pressure below vacuum bag 306 is released. Curing composite laminate 302 at atmospheric pressure can reduce frothing of low viscosity resins and adhesives during cure.

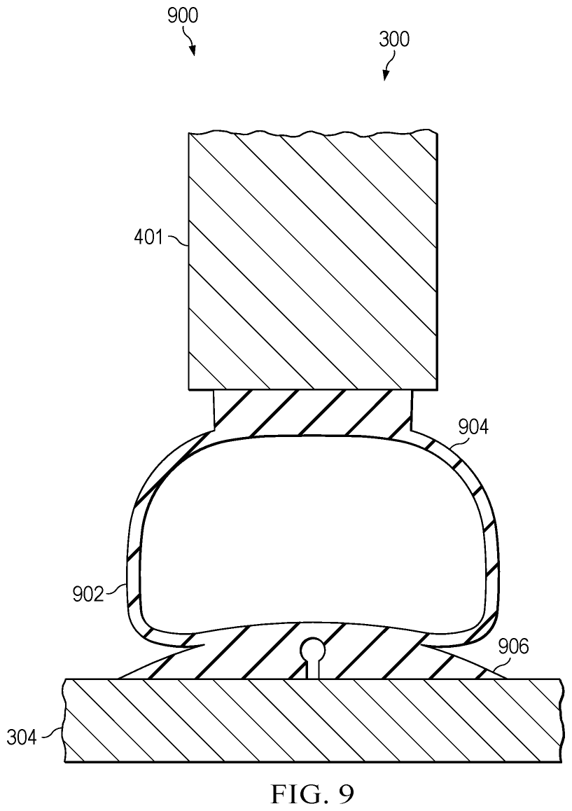

Turning now to FIG. 9, an illustration of a cross-sectional view of a seal of a double vacuum processing system is depicted in accordance with an illustrative embodiment. View 900 is a view within the box in view 800 of FIG. 8. In view 900, seal 902 is connected to rigid chamber 401. When rigid chamber 401 is lowered towards cure tool 304, seal 902 is in contact with cure tool 304.

Seal 902 includes bladder 904 and suction foot 906. In some illustrative examples, bladder 904 can be inflated to change a pressure applied by seal 902. Suction foot 906 can maintain second vacuum zone 506 when positive pressure is applied within rigid chamber 401.

The illustration of double vacuum processing system 300 in FIGS. 3-9 is not meant to imply physical or architectural limitations to the manner in which an illustrative embodiment may be implemented. Other components in addition to or in place of the ones illustrated may be used. Some components may be unnecessary. For example, although clamps 310 connected to cure tool 304 are shown in FIGS. 3-9, any desirable retention device can be utilized to maintain rigid chamber 401 against cure tool 304. In another example, clamps 310 can be connected to rigid chamber 401 instead of cure tool 304.

As yet another example, although first vacuum zone 312 is depicted as being formed first, in other illustrative examples, second vacuum zone 506 can be formed first. For example, vacuum bag 306 can be connected to rigid chamber 401 such that second vacuum zone 506 is present prior to sealing vacuum bag 306 to cure tool 304. In these illustrative examples, rigid chamber 401 and vacuum bag 306 are raised and lowered relative to composite laminate 302 and cure tool 304 as one assembly.

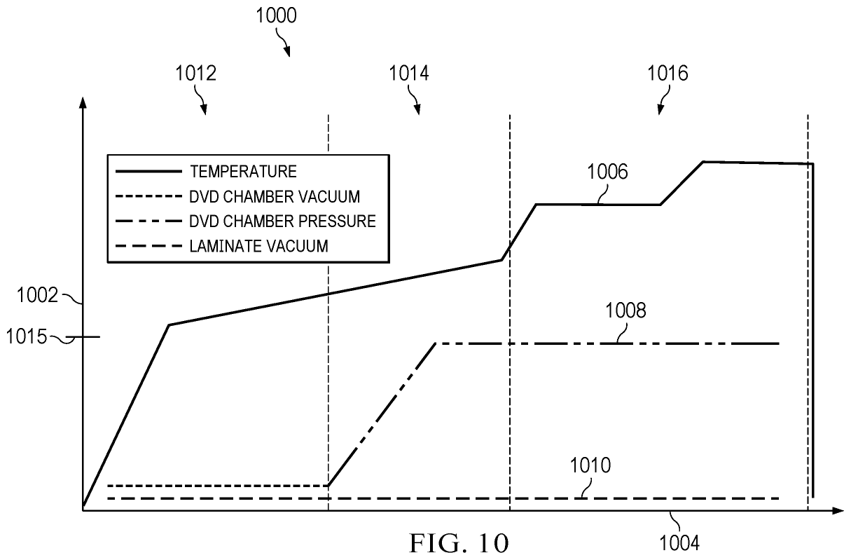

Turning now to FIG. 10, an illustration of cure cycle graph is depicted in accordance with an illustrative embodiment. Thermal cycle graph 1000 is an example of a thermal cycle that can be utilized in double vacuum processing system 202 of FIG. 2. Thermal cycle graph 1000 is an example of a thermal cycle that can be utilized in double vacuum processing system 300 of FIGS. 3-9. In thermal cycle graph 1000, y-axis 1002 is pressure or temperature. In thermal cycle graph 1000, x-axis 1004 is time. Line 1006 is heat applied to a composite laminate. Line 1006 comprises temperature data. Line 1008 represents pressure within the second vacuum zone. Line 1010 represents pressure within the first vacuum zone containing the composite laminate.

As depicted, both first vacuum zone and second vacuum zone are under vacuum as heat is applied to the composite laminate during degassing 1012. Heat is applied to the composite laminate as the second vacuum zone is vented and then pressure is increased during reconsolidation 1014. Pressure within the second vacuum zone is maintained above atmospheric pressure at value 1015 during reconsolidation 1014 and curing 1016. In this illustrative example, a vacuum is maintained within the first vacuum zone during reconsolidation 1014 and curing 1016.

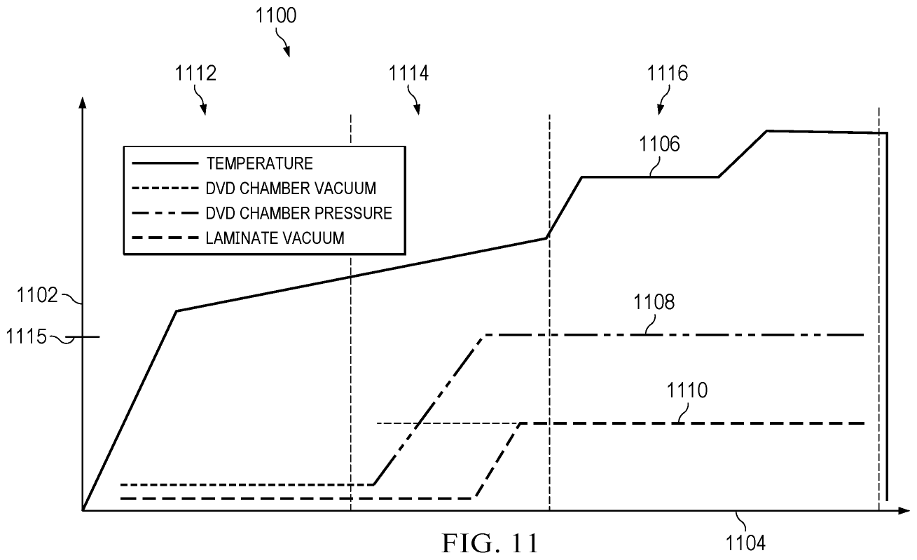

Turning now to FIG. 11, an illustration of cure cycle graph is depicted in accordance with an illustrative embodiment. Thermal cycle graph 1100 is an example of a thermal cycle that can be utilized in double vacuum processing system 202 of FIG. 2. Thermal cycle graph 1100 is an example of a thermal cycle that can be utilized in double vacuum processing system 300 of FIGS. 3-10. In thermal cycle graph 1100, y-axis 1102 is pressure or temperature. In thermal cycle graph 1100, x-axis 1104 is time. Line 1106 is heat applied to a composite laminate. Line 1106 comprises temperature data. Line 1108 represents pressure within the second vacuum zone. Line 1110 represents pressure within the first vacuum zone containing the composite laminate.

As depicted, both first vacuum zone and second vacuum zone are under vacuum as heat is applied to the composite laminate during degassing 1112. In some illustrative examples, degassing 1112 is performed while the vacuum and the second vacuum are regulated to be substantially the same. Heat is applied to the composite laminate as the second vacuum zone is vented and then pressure is increased during reconsolidation 1114. Pressure within the second vacuum zone is maintained above atmospheric pressure at value 1115 during curing 1116. In this illustrative example, the vacuum is released in the first vacuum zone after the second vacuum zone reaches atmospheric pressure. In this illustrative example, the first vacuum zone reaches atmospheric pressure prior to curing 1116. In this illustrative example, the first vacuum zone reaches atmospheric pressure prior to curing 1116.

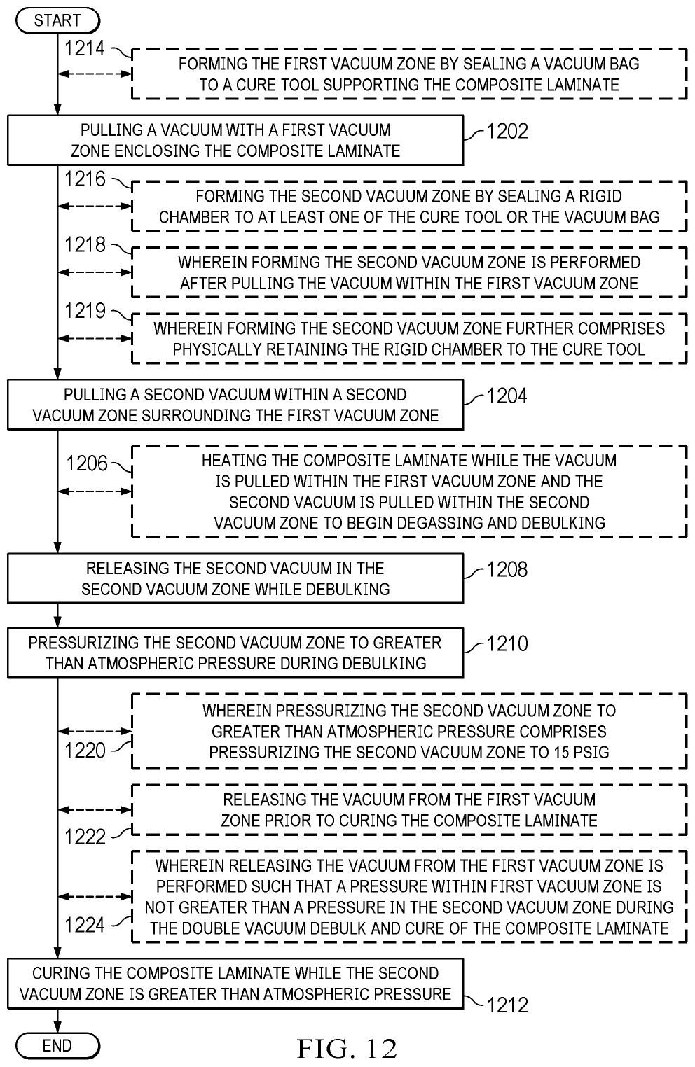

Turning now to FIG. 12, a flowchart of a method of performing a double vacuum debulk and cure on a composite laminate is depicted in accordance with an illustrative embodiment. Method 1200 can be used to produce a portion of aircraft 100. Method 1200 can utilize double vacuum processing system 202 of FIG. 2. Method 1200 can utilize double vacuum processing system 300 of FIGS. 3-9. Method 1200 can be performed using thermal cycle graph 1000 of FIG. 10. Method 1200 can be performed using thermal cycle graph 1100 of FIG. 11.

Method 1200 pulls a vacuum within a first vacuum zone enclosing the composite laminate (operation 1202). Method 1200 pulls a second vacuum within a second vacuum zone surrounding the first vacuum zone (operation 1204). Method 1200 releases the second vacuum in the second vacuum zone while debulking (operation 1208). Method 1200 pressurizes the second vacuum zone to greater than atmospheric pressure during debulking (operation 1210). Method 1200 cures the composite laminate while the second vacuum zone is greater than atmospheric pressure (operation 1212). Afterwards, method 1200 terminates.

In some illustrative examples, method 1200 heats the composite laminate while the vacuum is within the first vacuum zone and the second vacuum is within the second vacuum zone to begin degassing and debulking (operation 1206). In some illustrative examples, degassing is performed while the vacuum and the second vacuum are regulated to be substantially the same. In some illustrative examples, method 1200 forms the first vacuum zone by sealing a vacuum bag to a cure tool supporting the composite laminate (operation 1214). In some illustrative examples, method 1200 forms the second vacuum zone by sealing a rigid chamber to at least one of the cure tool or the vacuum bag (operation 1216). In some illustrative examples, forming the second vacuum zone is performed after pulling the vacuum within the first vacuum zone (operation 1218). In some illustrative examples, forming the second vacuum zone further comprises physically retaining the rigid chamber to the cure tool (operation 1219).

In some illustrative examples, pressurizing the second vacuum zone to greater than atmospheric pressure comprises pressurizing the second vacuum zone to 15 psig (operation 1220). In some illustrative examples, method 1200 releases the vacuum from the first vacuum zone prior to curing the composite laminate (operation 1222). In some illustrative examples, releasing the vacuum from the first vacuum zone is performed such that a pressure within first vacuum zone is not greater than a pressure in the second vacuum zone during the double vacuum debulk and cure of the composite laminate (operation 1224). In some illustrative examples, the vacuum is released in the first vacuum zone after the second vacuum zone reaches atmospheric pressure.

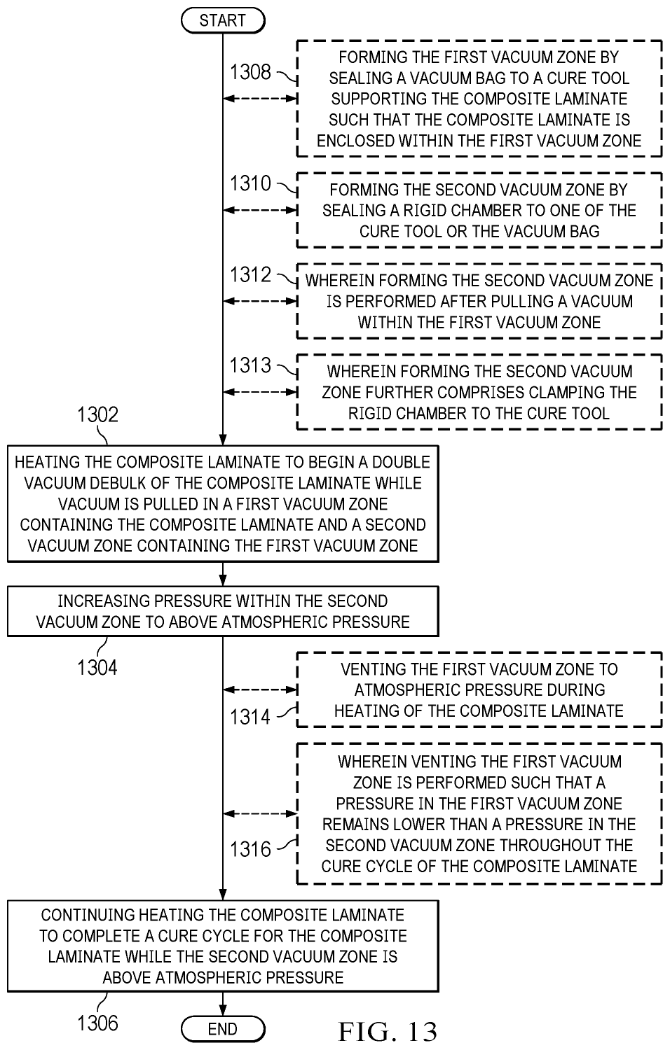

Turning now to FIG. 13, a flowchart of a method of performing a double vacuum debulk and cure on a composite laminate is depicted in accordance with an illustrative embodiment. Method 1300 can be used to produce a portion of aircraft 100. Method 1300 can utilize double vacuum processing system 202 of FIG. 2. Method 1300 can utilize double vacuum processing system 300 of FIGS. 3-9. Method 1300 can be performed using thermal cycle graph 1000 of FIG. 10. Method 1300 can be performed using thermal cycle graph 1100 of FIG. 11.

Method 1300 heats the composite laminate to begin a double vacuum debulk of the composite laminate while vacuum is pulled in a first vacuum zone containing the composite laminate and a second vacuum zone containing the first vacuum zone (operation 1302). Method 1300 increases pressure within the second vacuum zone to above atmospheric pressure (operation 1304). Method 1300 continues heating the composite laminate to complete a cure cycle for the composite laminate while the second vacuum zone is above atmospheric pressure (operation 1306). Afterwards, method 1300 terminates.

In some illustrative examples, method 1300 forms the first vacuum zone by sealing a vacuum bag to a cure tool supporting the composite laminate such that the composite laminate is enclosed within the first vacuum zone (operation 1308). In some illustrative examples, method 1300 forms the second vacuum zone by sealing a rigid chamber to one of the cure tool or the vacuum bag (operation 1310). In some illustrative examples, forming the second vacuum zone is performed after pulling a vacuum within the first vacuum zone (operation 1312). In some illustrative examples, forming the second vacuum zone further comprises clamping the rigid chamber to the cure tool (operation 1313).

In some illustrative examples, method 1300 vents the first vacuum zone to atmospheric pressure during heating of the composite laminate (operation 1314). In some illustrative examples, venting the first vacuum zone is performed such that a pressure in the first vacuum zone remains lower than a pressure in the second vacuum zone throughout the cure cycle of the composite laminate (operation 1316).

As used herein, the phrase “at least one of,” when used with a list of items, means different combinations of one or more of the listed items may be used and only one of each item in the list may be needed. For example, “at least one of item A, item B, or item C” may include, without limitation, item A, item A and item B, or item B. This example also may include item A, item B, and item C or item B and item C. Of course, any combinations of these items may be present. In other examples, “at least one of” may be, for example, without limitation, two of item A; one of item B; and ten of item C; four of item B and seven of item C; or other suitable combinations. The item may be a particular object, thing, or a category. In other words, at least one of means any combination items and number of items may be used from the list but not all of the items in the list are required.

As used herein, “a number of,” when used with reference to items means one or more items.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step.

In some alternative implementations of an illustrative embodiment, the function or functions noted in the blocks may occur out of the order noted in the figures. For example, in some cases, two blocks shown in succession may be executed substantially concurrently, or the blocks may sometimes be performed in the reverse order, depending upon the functionality involved. Also, other blocks may be added in addition to the illustrated blocks in a flowchart or block diagram. Some blocks may be optional. For example, operation 1214 through operation 1224 may be optional. For example, operation 1308 through operation 1316 may be optional.

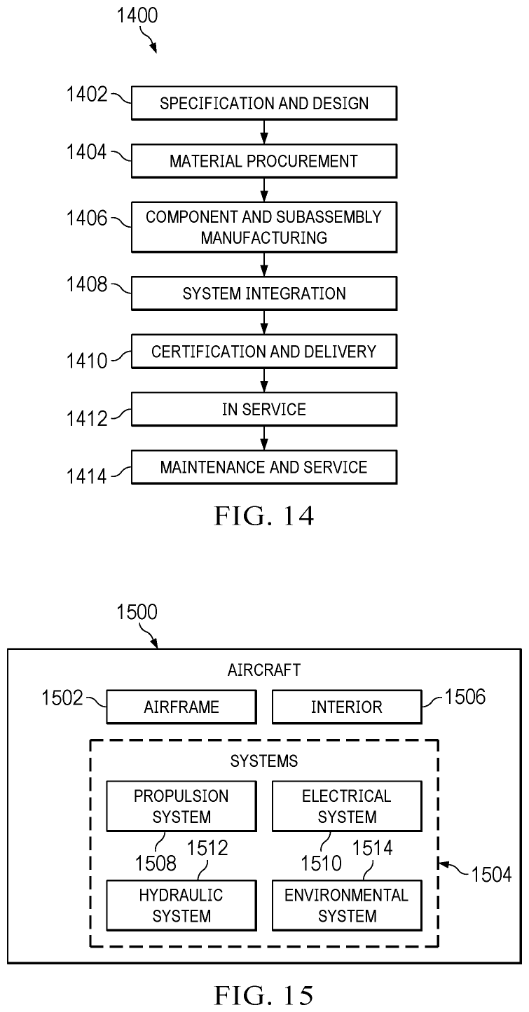

Illustrative embodiments of the present disclosure may be described in the context of aircraft manufacturing and service method 1400 as shown in FIG. 14 and aircraft 1500 as shown in FIG. 15. Turning first to FIG. 14, an illustration of an aircraft manufacturing and service method in a form of a block diagram is depicted in accordance with an illustrative embodiment. During pre-production, aircraft manufacturing and service method 1400 may include specification and design 1402 of aircraft 1500 in FIG. 15 and material procurement 1404.

During production, component and subassembly manufacturing 1406 and system integration 1408 of aircraft 1500 takes place. Thereafter, aircraft 1500 may go through certification and delivery 1410 in order to be placed in service 1412. While in service 1412 by a customer, aircraft 1500 is scheduled for routine maintenance and service 1414, which may include modification, reconfiguration, refurbishment, or other maintenance and service.

Each of the processes of aircraft manufacturing and service method 1400 may be performed or carried out by a system integrator, a third party, and/or an operator. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 15, an illustration of an aircraft in a form of a block diagram is depicted in which an illustrative embodiment may be implemented. In this example, aircraft 1500 is produced by aircraft manufacturing and service method 1400 of FIG. 14 and may include airframe 1502 with plurality of systems 1504 and interior 1506. Examples of systems 1504 include one or more of propulsion system 1508, electrical system 1510, hydraulic system 1512, and environmental system 1514. Any number of other systems may be included.

Apparatuses and methods embodied herein may be employed during at least one of the stages of aircraft manufacturing and service method 1400. One or more illustrative embodiments may be manufactured or used during at least one of component and subassembly manufacturing 1406, system integration 1408, in service 1412, or maintenance and service 1414 of FIG. 14.

A portion of airframe 1502 of aircraft 1500 can be formed by one of method 1200 or method 1300. At least one of method 1200 or method 1300 can be performed during component and subassembly manufacturing 1406. A composite structure formed using one of method 1200 or method 1300 can be present and utilized during in service 1412. At least one of method 1200 or method 1300 can be performed during maintenance and service 1414 to form a replacement part.

The illustrative examples provide a double vacuum debulk with a low positive pressure cure process. The illustrative examples provide methods of curing production composite laminates without the need for an autoclave. The first portion of the thermal cycle is performed under double vacuum to fully de-air and consolidate the laminate. The second portion of the thermal cycle is performed under positive pressure. In some illustrative examples, the second portion of the thermal cycle is performed under low level positive pressure. Low level positive pressure is 15 PSI (˜1 atmosphere), or less, for this application. The advantage of applying positive pressure for the second portion of the thermal cycle is that it provides additional process robustness to compensate for off-nominal cure conditions that may occur in day to day operations.

The illustrative examples will increase the processing capability beyond that of double vacuum debulk process alone and increase process robustness. The illustrative examples provide for curing of co-bonded adhesive film joints in a double vacuum debulk system. A co-bond is when one composite element is simultaneously being cured and bonded to a second composite element using a film adhesive. The second composite element can be pre-cured or un-cured. An example co-bonding being when a composite wing skin is cured while simultaneously bonding pre-cured stringers to it using film adhesive. In this scenario a conventional double vacuum debulk would result in a well consolidated wing skin laminate, but could create a bonded joint between the wing skin and wing stringer with some level of porosity.

The illustrative examples provide a modified double vacuum debulk protocol for consolidating a composite laminate that is compatible with a film adhesive. A film adhesive can continue generating volatiles during the single vacuum portion of a conventional double vacuum debulk cure cycle. Gas generation can be aggravated by the negative pressure within the vacuum bag. Negative pressure will tend to make gas bubbles evolve at lower temperatures and grow larger than they would under positive pressure.

The illustrative examples solve problems of porosity by applying positive pressure during a single vacuum portion of the cure cycle. Pressuring the rigid chamber to greater than atmospheric pressure cancels out the negative pressure within the vacuum bag and will result in much lower porosity in adhesive bond lines. The addition of positive pressure to the single vacuum portion of the thermal cycle enables a large expansion of the double vacuum debulk process applicability envelope.

The application of positive pressure post double vacuum debulk processing can mitigate many nuisance issues that can compromise laminate quality. Positive pressure can negate the effect of ambient conditions and altitude, for example. Out of autoclave processes work best when done at very high vacuum levels, i.e. −29.7 inHg or higher. On poor weather days when ambient conditions only allow for −28.5 inHg there can be a noticeable increase in laminate porosity. The altitude of the production facility also can affect laminate quality. A facility located at 5000 feet in elevation would only be able to draw about −25 inHg of vacuum. The quality of vacuum bag only cured laminates cured at this elevation would be significantly impacted. The illustrative examples will eliminate these problems. The double vacuum debulk process is unaffected by reduced atmospheric pressures related to weather or elevation. As long as all of the atmosphere is evacuated from the vacuum bag and the rigid chamber, the double vacuum debulk process will function as intended regardless of ambient conditions. The addition of one atmosphere of pressure during the single vacuum cure stage of the thermal cycle will compensate for reduced vacuum levels during that portion of the thermal cycle.

Some of the illustrative examples utilize 15 psig or less within the second vacuum zone. By being at or below 15 psig, the rigid chamber is not subject to American Society of Mechanical Engineers ASME pressure vessel certification requirements.

The illustrative examples involves the following operations: pull full vacuum on the laminate, evacuate the rigid chamber over the laminate, heat the laminate under double vacuum to the prescribed temperature and time, vent the rigid chamber while maintaining full vacuum on laminate bag, pressurize the rigid chamber to a pressure greater than atmospheric pressure, and optionally vent the laminate vacuum bag to atmosphere, and complete the cure cycle under single vacuum (unless vented) at the positive pressure (up to 15 psig).

For some material systems and part configurations it is beneficial to vent the laminate vacuum bag to atmosphere once the rigid chamber is pressurized. Some material systems tend to foam, or froth, when exposed to the negative pressure environment inside the laminate vacuum bag. Venting the laminate vacuum bag eliminates the negative pressure inside the bag and the positive pressure (up to 15 psig) within the rigid chamber will press on the laminate vacuum bag film to collapse bubbles and consolidate the laminate and film adhesive.

Modifications can be made to the double vacuum debulk system to allow it to operate with up to 15 psig of internal pressure. The rigid chamber/apparatus needs to be designed to withstand one atmosphere of positive pressure in addition to the existing requirement of an atmosphere of negative pressure. The lip seal around the base the double vacuum debulk DVD chamber that provides vacuum integrity between the DVD chamber and the base tool is also modified. In some illustrative examples, a lip seal that can contain both negative and positive pressures is used between the rigid chamber and the cure tool. Retention devices/latches can be used to positively fix the rigid chamber lid to the cure tool. Plumbing changes have been made to add the piping for the compressed air, pressure regulation devices, and blow off valve to prevent over pressurization.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different features as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of performing a double vacuum debulk and cure on a composite laminate, the method comprising:
pulling a vacuum within a first vacuum zone enclosing the composite laminate;
pulling a second vacuum within a second vacuum zone surrounding the first vacuum zone;
releasing the second vacuum in the second vacuum zone while debulking;
pressurizing the second vacuum zone to greater than atmospheric pressure during debulking; and
curing the composite laminate while the second vacuum zone is greater than atmospheric pressure.

2. The method of claim 1 further comprising:
heating the composite laminate while the vacuum is pulled within the first vacuum zone and the second vacuum is pulled within the second vacuum zone to begin degassing and debulking.

3. The method of claim 1 further comprising:
releasing the vacuum from the first vacuum zone prior to curing the composite laminate.

4. The method of claim 3, wherein releasing the vacuum from the first vacuum zone is performed such that a pressure within first vacuum zone is not greater than a pressure in the second vacuum zone during the double vacuum debulk and cure of the composite laminate.

5. The method of claim 3, wherein releasing the vacuum in the first vacuum zone is performed after the second vacuum zone reaches atmospheric pressure.

6. The method of claim 1 further comprising:
forming the first vacuum zone by sealing a vacuum bag to a cure tool supporting the composite laminate.

7. The method of claim 6 further comprising:
forming the second vacuum zone by sealing a rigid chamber to at least one of the cure tool or the vacuum bag.

8. The method of claim 7, wherein forming the second vacuum zone is performed after pulling the vacuum within the first vacuum zone.

9. The method of claim 7, wherein forming the second vacuum zone further comprises physically retaining the rigid chamber to the cure tool.

10. The method of claim 1, wherein pressurizing the second vacuum zone to greater than atmospheric pressure comprises pressurizing the second vacuum zone to 15 psig.

11. The method of claim 1, wherein degassing is performed while the vacuum and the second vacuum are regulated to be substantially the same.

12. A portion of an aircraft assembled according to the method of claim 1.

13. A method of performing a double vacuum debulk and cure on a composite laminate, the method comprising:
heating the composite laminate to begin a double vacuum debulk of the composite laminate while vacuum is pulled in a first vacuum zone containing the composite laminate and a second vacuum zone containing the first vacuum zone;
increasing pressure within the second vacuum zone to above atmospheric pressure; and
continuing heating the composite laminate to complete a cure cycle for the composite laminate while the second vacuum zone is above atmospheric pressure.

14. The method of claim 13 further comprising:
venting the first vacuum zone to atmospheric pressure during heating of the composite laminate.

15. The method of claim 14, wherein venting the first vacuum zone is performed such that a pressure in the first vacuum zone remains lower than a pressure in the second vacuum zone throughout the cure cycle of the composite laminate.

16. The method of claim 13 further comprising:
forming the first vacuum zone by sealing a vacuum bag to a cure tool supporting the composite laminate such that the composite laminate is enclosed within the first vacuum zone.

17. The method of claim 16 further comprising:
forming the second vacuum zone by sealing a rigid chamber to one of the cure tool or the vacuum bag.

18. The method of claim 17, wherein forming the second vacuum zone is performed after pulling a vacuum within the first vacuum zone.

19. The method of claim 17, wherein forming the second vacuum zone further comprises clamping the rigid chamber to the cure tool.

20. A portion of an aircraft assembled according to the method of claim 13.

21. A system comprising:
a rigid chamber comprising walls and a cavity formed by the walls; and
seals connected to the walls of the rigid chamber, the seals configured to maintain a vacuum zone formed within the cavity between the rigid chamber and a cure tool when a positive pressure or a negative pressure is within the vacuum zone.

22. The system of claim 21 further comprises:
a pressure relief valve connected to the rigid chamber configured to release pressure above a set point.

23. The system of claim 21 further comprising:
the cure tool, the cure tool configured to support a composite laminate during curing; and
a number of retention clamps configured to hold the rigid chamber against the cure tool.

24. The system of claim 23, wherein the number of retention clamps are connected to the cure tool.

25. Fabricating a portion of an aircraft using the system of claim 21.
